(19) United States
(12) Patent Application Publication
(10) Pub. No.: US 2009/0015374 A1
(43) Pub. Date: Jan. 15, 2009

(54) USER AUTHENTICATION SYSTEM AND METHOD

(76) Inventor: Riddhiman Ghosh, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/775,128

(22) Filed: Jul. 9, 2007

(51) Int. Cl. G08B 29/00

(52) U.S. Cl. 340/5.64

(57) ABSTRACT

A system and method of, and a service that employs, user authentication each employs a bluecard created by the service and stored on a personal trusted device (PTD). The system includes the service and the bluecard. The bluecard includes a unique identifier derived from a hardware address of the PTD. The PTD and the service communicate with one another over a personal area network (PAN) during user authentication. The method includes creating the bluecard and pushing the bluecard onto the PTD using an object exchange (OBEX) protocol of the PAN. The service includes a terminal and the created bluecard. The terminal has the PAN that communicates with the PTD. The bluecard is subsequently sent to the service from the PTD for user authentication via the PAN.

### CROSS-REFERENCE TO RELATED APPLICATIONS

N/A

### STATEMENT REGARDING FEDERALLY SPONSORED RESEARCH OR DEVELOPMENT

N/A

### BACKGROUND

1. Technical Field

The invention relates to user authentication. In particular, the invention relates to wireless authentication and login with a service.

2. Description of Related Art

User authentication has become a ubiquitous part of modern user-oriented systems or services. Services must generally control user access for various reasons ranging from security to bandwidth and loading considerations. For example, services, such as automated teller machines (ATMs), point of sale (POS) terminals, pay-for-service systems, and various other fee-based dispensing systems, must generally verify a user's identity to guard against fraudulent access (e.g., identity theft) and/or to insure payment for services. Free internet access points and certain information dispensing kiosks may benefit from access control by regulating a total number of users. Facility access gates or doors often employ authentication to regulate who is entering a building. Loyalty reward and coupon dispensing systems may need to know a user's identity to coordinate with and update a user's account. Therefore, users wishing to gain access to such services generally are required to submit to some form of user identification and/or authentication.

Currently, a wide variety of different user authentication technologies are deployed and in common use. Such user authentication technologies often employ cards or devices that must be carried by a user to accomplish user authentication. Examples include, but are not limited to, bar-code or magnetic strip based ID cards, credit/ATM cards often having either a magnetic strip or embedded integrated circuit, and radio frequency identification (RFID) cards, units or tags (e.g., key chain remote pay devices). In addition, direct user interaction with a terminal of the service (e.g., entry of a personal identification number (PIN) or password) is often used either instead of or in addition to one of the above-listed technologies for user authentication. Unfortunately, each of these technologies generally requires the user to carry a separate, typically service-specific device or card to gain access to a given service.

Recently, cell phones have begun to play a role in user authentication. For example, text messaging (e.g., short message service or SMS text messaging) or using the cell phone to call an access number and enter a password or PIN are employed in some systems for user authentication. While offering a potential for replacing some of the unique devices and cards used for authentication, the use of cell phones has generally failed to gain wide acceptance due to significant drawbacks associated with cell phone based authentication protocols. For example, using a cell phone often involves a fee-based access (e.g., text messaging) which is sometimes objectionable to a user. Moreover, existing cell phone based authentication protocols using SMS text messaging or phone-in password/PIN submission generally eliminates direct service-based control/ownership of user authentication. Additionally, for security and other reasons, many user authentication systems require that devices/cards be issued by and remain the property of the service (see for example, the Europay, Mastercard, Visa International or EMV payment standard).

### BRIEF SUMMARY

In some embodiments of the present invention, a user authentication system is provided. The user authentication system comprises a service employing user authentication to allow a user in possession of a personal trusted device (PTD) to access the service. The user authentication system further comprises a bluecard. The bluecard comprises a unique identifier derived from a hardware address of the PTD. The bluecard is generated by the service and stored in the PTD. The PTD and the service communicate with one another over a wireless personal area network (PAN) during user authentication.

In other embodiments of the present invention, a method of user authentication is provided. The method of user authentication comprises creating a bluecard. The bluecard comprises an identifier derived from a hardware address of a personal trusted device (PTD). The method of user authentication further comprises pushing the bluecard onto the PTD using an object exchange (OBEX) protocol of a personal area network (PAN). The bluecard is stored by the PTD for later retrieval during user authentication.

In other embodiments of the present invention, a service employing user authentication to allow a user to access the service is provided. The service comprises a terminal having a wireless personal area network (PAN) that communicates with a personal trusted device (PTD) of the user. The service further comprises a bluecard generated by the service and stored on the PTD using the wireless PAN. The bluecard comprises an identifier created from a hardware address of the PTD. During user authentication, the user is authenticated with the service by the stored bluecard being transmitted to the terminal using the wireless PAN.

Certain embodiments of the present invention have other features one or both of in addition to and in lieu of the features described hereinabove. These and other features of the invention are detailed below with reference to the following drawings.

### BRIEF DESCRIPTION OF THE DRAWINGS

The various features of the embodiments of the present invention may be more readily understood with reference to the following detailed description taken in conjunction with the accompanying drawings, where like reference numerals designate like structural elements, and in which:

FIG. 1 illustrates a block diagram of a user authentication system according to an embodiment of the present invention.

FIG. 2 illustrates an exemplary bluecard and contents thereof comprising a vCard file format according to an embodiment of the present invention.

FIG. 3 illustrates a flow chart of a method of user authentication according to an embodiment of the present invention.

FIG. 4 illustrates a flow chart of an exemplary device pairing between a service and a PTD, according to various embodiments of the present invention.

FIG. 5 illustrates a flow chart of a user login portion of the method of user authentication of FIG. 3, according to an embodiment of the present invention.

FIG. 6 illustrates a block diagram of a service employing user authentication according to an embodiment of the present invention.

### DETAILED DESCRIPTION

Embodiments of the present invention facilitate authentication of a user seeking access to a service. In particular, the present invention establishes and verifies an identity of the user prior to granting access to the service. Authentication is accomplished using an interaction between the service and a personal trusted device (PTD) of the user. In particular, the authentication is tied or directly coupled to a specific PTD in possession of the user. The interaction occurs over a personal area network (PAN) that interconnects the service and the PTD. In some embodiments, the PAN is a wireless PAN. The PTD may be any of a number of electronic devices including, but not limited to, a personal digital assistant (PDA), a cellular telephone, and a laptop, palm top, or similar portable/mobile computer, that may be carried by or otherwise be in the possession of a user.

During the authentication interaction, a specific data object or data structure is interchanged between the PTD and the service over the PAN. The interchanged data structure is described and defined herein as a “bluecard”. As defined, the ‘bluecard’ is essentially an electronic token or certificate that is passed back and forth between the PTD and the service. In particular, the bluecard received by the service along with other characteristics of the interaction serves as a means of identifying the user to the service during user authentication. According to various embodiments of the present invention, the bluecard is passed back and forth between the PTD and the service using the PAN.

According to various embodiments of the present invention, the bluecard is created or generated by the service and is subsequently passed to and stored on the PTD. Generation and storage of the bluecard may occur when the user registers with the service, for example. Later, during user authentication, the user selects and passes back to the service the previously stored bluecard. If authentication using the bluecard is successful, access to the service may be granted to the user. In some embodiments, the bluecard may be periodically updated by the service subsequent to being stored on the PTD. Updating may facilitate one or more of repurposing or revalidating the bluecard, for example. The service is solely responsible for creating, updating and otherwise controlling the contents of the bluecard, according to some embodiments of the present invention. In effect, while stored on the PTD in the user's possession, the bluecard is “owned” by the service.

In some embodiments, the PTD may store multiple bluecards, each bluecard being associated with a different service. When access to a particular service is desired, the user merely selects an appropriate one of the multiple stored bluecards and passes the selected bluecard to the service for authentication. In some embodiments, the bluecard-equipped PTD essentially takes the place of radio frequency identification (RFID) devices, credit cards, and similar means for user authentication currently employed by services requiring access control. In such embodiments, a user need not carry multiple means for user authentication but instead may employ the PTD as a sole or primary means for accessing the multiple services.

For example, the PTD may be the user's cell phone which is already being carried by the user. According to various embodiments of the present invention, the cell phone and the bluecards stored therein may effectively replace a multitude of other user identification or authorization devices normally carried by the user, for example an ATM card.

In some embodiments, the bluecard serves as more than simply a means for user authentication or identification. For example, the bluecard may carry or convey additional information that further identifies the user to the service. In particular, the bluecard may include a user ID that corresponds to an entry point in a database of the service associated with the user. In addition, information regarding user preferences relative to the service, user loyalty data or points gained by using the service, and even coupons for use in conjunction with the service may be included in various optional data fields of the bluecard, for example.

According to various embodiments, the bluecard and its contents are generated and controlled by the service as mentioned above. In such embodiments, the user may not have access to or not even have knowledge of the bluecard contents. For example, the contents of the bluecard may be encrypted using a key not available to the user. As such, the service may update and even repurpose the bluecard while the user is logged onto and accessing the service without the user's knowledge, according to some embodiments. Updating/repurposing the bluecard without the user's knowledge may contribute to security of the bluecard, for example.

As used herein, a personal area network (PAN) refers to a short-path or short-range communications network having a range of less than about 100 meters and more typically, less than about 10 meters. The PAN provides a means for connecting and exchanging data between devices that are in relatively close proximity to one another (e.g., 10 meters). A wireless PAN is a network that communicates without need for a wired connection. The wireless PAN is distinguished from other wireless networks such as, but not limited to, WiFi and IEEE 802.11(a)(b) and (g), primarily by the essentially shorter inter-device distances that are allowed by the wireless PAN. Examples of wireless PANs include, but are not limited to, the Bluetooth™ wireless PAN and IrDA® infrared optical PAN.

Bluetooth™ is a widely recognized industry standard for a radio-based wireless PAN. The Bluetooth™ wireless PAN employs a low power radio link in a globally unlicensed short-range radio frequency band at about 2.4 GHz. The Bluetooth™ standard defines and standardizes short-path or short-range interconnectivity and data exchange between electronic devices including, but not limited to, personal digital assistants (PDA), cellular telephones, portable/mobile computers (e.g., laptop or palm top computers), wireless headsets, printers, digital cameras, global positioning systems (GPS), and video game consoles. Bluetooth™ is a registered trademark of the Bluetooth Special Interest Group (SIG), Inc., Bellevue, Wash., a not-for-profit trade association. The Bluetooth™ SIG establishes and maintains the standards (i.e., Bluetooth™ profiles) that control Bluetooth™ compatibility as well as issues licenses for use of Bluetooth™ in Bluetooth™ enabled devices and systems. Given the ubiquitous nature of Bluetooth™, hereinafter “Bluetooth™” will be referred to as simply “Bluetooth” without reference to the registered trademark symbol ‘™’ for simplicity of discussion and without loss of specificity.

IrDA® is a widely recognized industry communications protocol standard for short-range, free-space infrared-based optical PAN. Specifically, IrDA® defines a physical specification for connecting and communicating data between electronic devices over a short range, line-of-sight, infrared optical data link. A wide variety of devices are currently available that support IrDA® optical PAN including, but not limited to, personal digital assistants (PDA), cellular telephones, portable/mobile computers, wireless headsets, printers, digital cameras, and video game consoles. IrDA® is a registered trademark of Infrared Data Association (IrDA), Walnut Creek, Calif. For simplicity and without loss of specificity, hereinafter “IrDA® ” will be referred to simply as “IrDA” without reference to the registered trademark symbol.

Various embodiments of the present invention employ an object exchange (OBEX) protocol for passing the bluecard back and forth between the service and the PTD. OBEX is an object transfer protocol that defines data objects that can be exchanged between two devices and that establishes a communications protocol for exchanging the data objects. OBEX was originally developed by IrDA and was later adopted by the Bluetooth SIG for use with Bluetooth enabled devices. Generally, OBEX enables device applications to work over various communication schemes or protocol stacks (e.g., the Bluetooth profile stack or the IrDA profile stack). However, only connection-oriented OBEX is supported under Bluetooth. Among the device applications that have been developed using OBEX are file transfer profile (FTP), object push profile (OPP) and synchronization profile (SYNC).

OBEX may be used by a client device (i.e., requester) to push an object to and/or pull an object from a server device. Specifically, an OBEX client initiates a connection to the OBEX server. The OBEX client also can request authorization from the server. OBEX uses a binary formatted header in the form of a type-length-value triplet to exchange information about objects.

Object push profile (OPP) defines a simple object push/pull mechanism between OBEX devices (e.g., Bluetooth enabled telephones). Basic operations defined under OPP are ‘connect’, ‘disconnect’, ‘put’, ‘get’ and ‘abort’. Higher level features of OPP are Object Push, Business Card Pull and Business Card Exchange. The Object Push feature facilitates sending one or more objects from a Push Client to a Push Server. Object Push is mandatory under OPP. Business Card Pull allows an object representing an electronic business card to be pulled from the server by the client. The Business Card Exchange (BCE) differs from Business Card Pull in that BCE transfers a business card object from the client to the server as well as from the server to the client (i.e., a symmetrical exchange). Business Card Pull and Business Card Exchange are generally optional under OPP.

An object format that may be exchanged using OPP is defined by the well-known vCard file format (e.g., *.VCF files). Further information about the specifics of OBEX and OPP can be obtained from IrDA or Bluetooth SIG, Inc., in the form of specifications and standards. For example, Bluetooth Specification, Ver 1.1, Part K:10 Generic Object Exchange Profile, Pages 310-452, 22 February 2001, available at www.bluetooth.com, and incorporated by reference herein, defines OBEX and OPP with respect to Bluetooth. Implementation details are generally device specific but can be readily determined without undue experimentation.

As used herein, the article ‘a’ is intended to have its ordinary meaning in the patent arts, namely ‘one or more’. For example, ‘a bluecard’ means one or more bluecards and as such, ‘the bluecard’ means ‘the bluecard(s)’ herein. Further, examples herein are intended to be illustrative only and are presented for discussion purposes and not by way of limitation.

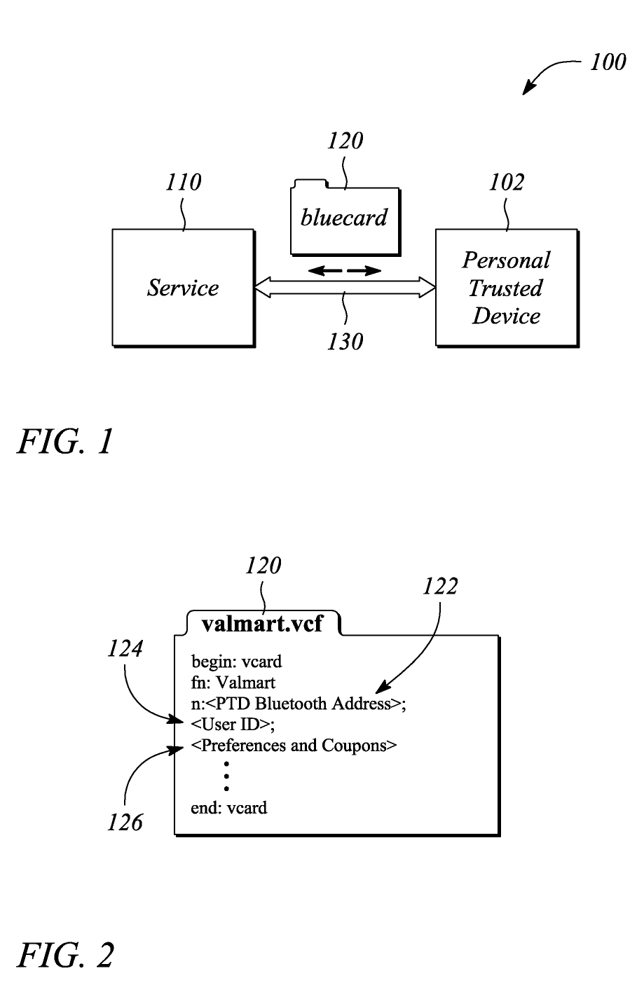

FIG. 1 illustrates a block diagram of a user authentication system 100 according to an embodiment of the present invention. The user authentication system 100 enables a user to access a service 110 by establishing the user's identity. In particular, the user authentication system 100 authenticates a user in possession of a specific personal trusted device (PTD) 102. The PTD 102 may be a cellular telephone (i.e., cell phone), for example. Once the user is authenticated, the user authentication system 100 may grant the user access to the service 110. The user authentication system 100 is applicable to a wide variety of services requiring or benefiting from controlled access by users including, but not limited to, point of sale (POS) systems, ATM systems, information distribution systems, and user loyalty and coupon generation systems.

As illustrated in FIG. 1, the user authentication system 100 comprises the service 110. The service 110 may be essentially any service that employs user authentication to regulate access to the service. In some embodiments, the service 110 comprises a terminal having a user interface (not separately illustrated). For example, the terminal may represent a POS terminal at a check-out line at a supermarket, hardware store, or department store. In another example, the POS terminal may be built into a gas pump or another vending machine. In another example, the terminal may be a kiosk that provides an authenticated user with one or more of information, access to the internet, access to a storage unit, coupons or other loyalty-related products, tokens, etc. In other words, the terminal may take on essentially any form consistent with or dictated by the service 110.

The user authentication system 100 further comprises a bluecard 120. The bluecard 120 is generated by the service 110 and stored in the PTD 102. For example, the bluecard 120 may be generated by the service 110 when the user initiates a registration with the service 110. After being generated by the service 110, the bluecard 120 is transferred or passed to the PTD 102 for storage. The bluecard 120 stored in the PTD 102 is subsequently transferred or passed to the service 110 to accomplish user authentication. In some embodiments, the bluecard 120 is updated by the service 110 after being generated and subsequently stored in the PTD 102. For example, the previously stored bluecard 120 may be replaced by a new bluecard 120 generated by the service 110. In some embodiments, updating may occur while the user is accessing the service 110 following registration. Updating the bluecard 120 facilitates adding and editing information that may be stored in the bluecard 120, for example. The service 110 is solely responsible for the contents of the bluecard 120. A personal area network PAN 130 is employed to transfer or pass the bluecard 120 to the PTD 102 for storage after the service 110 has generated the bluecard 120.

The bluecard 120 generated by the service 110 comprises a unique identifier derived from a hardware address of the PTD 102. In some embodiments, the hardware address further may be an address of or associated with the PAN 130.

In some embodiments, the unique identifier is a data field in a data structure of the bluecard 120 that encodes or represents the hardware address of the PTD 102. For example, the unique identifier may be simply the hardware address itself stored in the data field of the bluecard 120. In other embodiments, the unique identifier may be the hardware address combined with additional information or otherwise encoded and stored in the data structure field. For example, the hardware address may be encoded with an error correction code and then stored in the bluecard 120 data field.

In some embodiments, the wireless PAN 130 is a Bluetooth wireless PAN. In such embodiments, the hardware address of the PTD 102 is the Bluetooth hardware address associated with or assigned to the PTD 102. For example, the PTD 102 may be a Bluetooth enabled cell phone and the hardware address is the Bluetooth address of the cell phone. In other embodiments, the wireless PAN 130 may be an IrDA optical PAN and the hardware address is the IrDA hardware address of the PTD 102. In yet other embodiments, a wireless PAN 130 other than Bluetooth or IrDA is employed.

In some embodiments, the bluecard 120 is transferred to the PTD 102 using an object push profile (OPP) of an object exchange (OBEX) protocol of the wireless PAN 130. For example, when the wireless PAN 130 is Bluetooth, the OPP under Bluetooth may be used to push the bluecard 120 onto the PTD in a manner analogous to pushing an electronic business card or calendar item using OPP under Bluetooth. Many Bluetooth enabled cell phones implement electronic business card exchange via OPP under OBEX, for example. Similarly, OPP of IrDA may be employed to push the bluecard 120 to the PTD according to another example.

In some embodiments, the bluecard 120 comprises a data structure consistent with or comprising a vCard file format. FIG. 2 illustrates an exemplary bluecard 120 and contents thereof comprising the vCard file format according to some embodiments. As illustrated in FIG. 2, the exemplary bluecard 120 comprises a first field 122 that encodes the hardware address of the PTD 102 (e.g., a cell phone Bluetooth hardware address). The exemplary bluecard 120 further comprises a second field 124 that encodes a user ID. The user ID may identify the user to the service (e.g., customer number) and may facilitate accessing an account for the user in a database of the service, for example. The user ID may be associated with and stored in the bluecard when the user registers with the service. The associated and stored user ID may be either a new user ID created during registration with the service or an existing or previously created user ID for the user, for example.

The exemplary bluecard 120 further comprises a third field 126. The third field 126 may encode user preferences or loyalty points accumulated by the user, is for example. As illustrated, the first field 122, the second field 124 and the third field 126 are concatenated together in a name field (i.e., “n:”) defined for the vCard file format. Alternatively, other conventional fields (e.g., the address field, etc.) of the vCard format could be used to hold some or all of the first, second, and third fields 122, 124, 126, if so intended. The exemplary bluecard may further comprise additional fields such as, but not limited to, a formatted name field (e.g., “fn: Valmart”). In general, an order, arrangement and naming of the fields within the bluecard 120 is arbitrary and is left up to a particular service implementation.

In some embodiments, the bluecard 120 is encrypted by the service 110. Encryption of the bluecard 120, or more specifically, encryption of the contents thereof, serves to prevent unauthorized access to the information stored in the bluecard 120. In addition, encryption may serve to prevent alteration or unauthorized duplication of the bluecard 120 by the user or another party other than the service 110.

In some embodiments, a symmetric key encryption is employed to encrypt the bluecard 120. In a symmetric encryption, the service 110 maintains a private key that is employed to both encrypt and decrypt the bluecard 120. In other embodiments, an asymmetric key encryption is employed to encrypt and decrypt the bluecard 120. In an asymmetric encryption, a pair of keys (e.g., a public key and a private key) is employed for encryption/decryption. Typically, the public key is used to encrypt and the private key is used to decrypt the bluecard 120.

In some embodiments, the service 110 comprises an application program that implements the functionality or operational characteristics of the various embodiments of the present invention. Specifically, in some embodiments, the service 110 comprises a computer program having instructions that, when executed, implement user registration. In some embodiments, registration comprises receiving the hardware address from the PTD 102 and creating or generating the bluecard 120 using the received hardware address to produce the unique identifier. Registration further comprises pushing the bluecard 120 onto the PTD 102 using the wireless PAN 130. In some embodiments, the service 110 comprises or further comprises a computer program having instructions that, when executed, implement authenticating a user. In some embodiments, user authentication comprises receiving a hardware address of the PTD 102 and receiving a bluecard 120 from the PTD 102. The hardware address and bluecard 120 are received via the wireless PAN 130. User authentication further comprises comparing the unique identifier of the bluecard 120 with the PTD 102 hardware address and granting the user access to the service 110 if the comparison indicates a match between the unique identifier and the hardware address. In some embodiments, access to the service 110 may further require the user to enter a knowledge-based response to a challenge by the service 110. For example, the service 110 can require entry of a personal identification number (PIN) prior to granting access. The computer program may be implemented using any suitable programming language compatible with an operating system of the service 110 including, but not limited to, Java, C/C++, Perl, etc., according to various embodiments of the present invention.

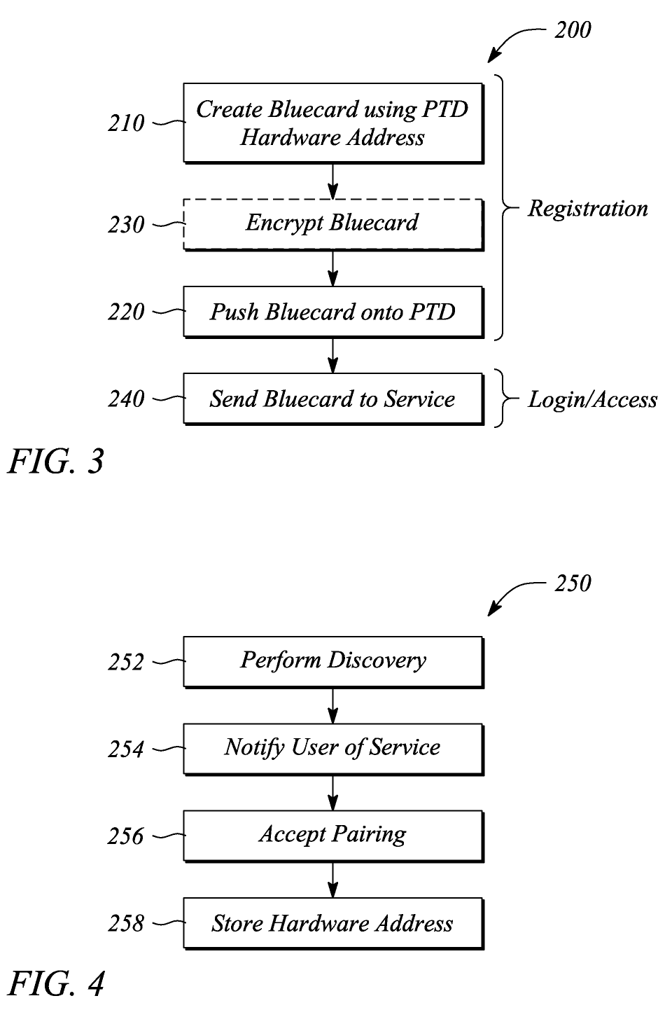

FIG. 3 illustrates a flow chart of a method 200 of user authentication according to an embodiment of the present invention. The method 200 of user authentication employs a personal area network (PAN) to interconnect a service that employs user authentication and a personal trusted device (PTD) of a user seeking authentication with the service. According to some embodiments of the present invention, the user is in possession of the PTD during the method 200. Possession of the PTD establishes the user's identification.

The method 200 of user authentication illustrated in FIG. 3 comprises creating 210 a bluecard. Creating 210 a bluecard comprises generating an identifier derived from a hardware address of the PTD. The identifier may be the hardware address of the PTD, in some embodiments. In other embodiments, the identifier may be generated from the hardware address through means for encoding an identifier. In either case, the identifier is directly tied to a specific hardware address of the particular PTD in an unambiguous and specific manner.

In some embodiments, creating 210 a bluecard further comprises adding optional additional information to the bluecard regarding the user. For example, additional information including, but not limited to, a user ID, user preferences, user privileges, coupons, and user loyalty information (e.g., frequent user tokens) may be added to the bluecard during creating 210 a bluecard.

Creating 210 a bluecard further comprises encoding contents of the bluecard (i.e., the identifier and optional additional information) in a form compatible with transmission over the PAN. For example, encoding may comprise encoding the bluecard contents as a file or data object such as, but not limited to, a vCard file format.

Implicit in creating 210 a bluecard is that the service has a priori knowledge of or has otherwise received the hardware address of the PTD. Receipt of the hardware address may occur during or as a normal result of a pairing between the PTD and service, in some embodiments. Pairing generally employs a pairing protocol of the PAN being used. For example, Bluetooth defines a pairing protocol that exchanges hardware addresses of devices being paired. In some embodiments, pairing is essentially similar to a conventional pairing associated with the PAN.

FIG. 4 illustrates a flowchart of an exemplary device pairing 250 between the service and the PTD, according to various embodiments of the present invention. Since pairing 250 between the service and the PTD is generally PAN-specific, pairing 250 illustrated in FIG. 4 is merely intended to be representative (i.e., exemplary) of a particular PAN-defined pairing (e.g., Bluetooth pairing). Although not illustrated in FIG. 3, pairing 250 between the service and the PTD is generally performed prior to creating 210 the bluecard. As such, pairing 250 between the service and the PTD may be considered a part of the method 200 of user authentication, according to some embodiments. For example, pairing 250 between the service and the PTD may be considered part of the registration portion of method 200.

As illustrated in FIG. 4, pairing 250 between the service and the PTD comprises performing 252 discovery. Discovery is a process that locates and identifies PAN-enabled devices within an operational range of the PAN. For example, Bluetooth defines a discovery protocol that locates and identifies all Bluetooth-enabled devices that are within range of the Bluetooth wireless PAN. In some embodiments, the service performs 252 discovery to locate and identify the user's PTD.

In some embodiments, pairing 250 between the service and the PTD further comprises notifying 254 the user of the service availability. In some embodiments, the user is notified 254 via the PAN. For example, with Bluetooth, notifying 254 the user comprises presenting ‘friendly’ names of the located and identified devices. The friendly names are presented to the located and identified devices including to the user's PTD (e.g., user's cell phone). The user is able to view the list of friendly names on the user interface of PTD (e.g., cell phone display). With other PANs, another means for notifying other than presenting friendly names may be employed to notify the user that the service is available.

In other embodiments, the service may notify 254 the user using a user interface of the service. For example, the service may display a message on a display unit of the service inviting the user to register with the service. The displayed message may comprise a friendly name (e.g., ‘Ted's Cell’) identifying the user's PTD, for example.

Pairing 250 between the service and the PTD further comprises accepting 256 the pairing. In some embodiments, the user accepts 256 the pairing by responding to the notification 254. For example, with Bluetooth, the user may accept 256 the pairing by selecting the presented friendly name corresponding to the user's PTD. For a Bluetooth wireless PAN, selecting the presented friendly name of the user's PTD sends a signal to the service that the user has accepted 256 the pairing. If the service notified 254 the user using a service-displayed message, the user may accept the pairing by pressing a key on the service user interface, for example. A wide variety of other means for accepting 256 the pairing are within the scope of the present invention including, but not limited to, sending a text message to the service using the PTD, and pressing a key or key sequence on the PTD whereupon an indication of the pressed key(s) is transmitted to the service using the PAN.

Pairing 250 between the service and the PTD further comprises storing 258 the hardware address of the PTD. In particular, once the pairing is accepted 256 by the user, the service records the hardware address of the user's PTD for later use. The pairing 250 between the service and the PTD essentially establishes that the user wants to register with the service and provides the PTD hardware address to the service. The stored hardware address may be employed in creating 210 the bluecard, in some embodiments.

In some embodiments, pairing 250 between the service and the PTD may further comprise verifying that the user has properly accepted 256 the pairing (not illustrated). For example, the service may display a pass phrase (e.g., random alphanumeric sequence) on the service display unit and prompt the user to enter the pass phrase using the PTD. The service then checks the entered pass phrase to verify that the user properly accepted 256 the pairing. With Bluetooth, the entered pass phrase is transmitted from the PTD to the service and may be checked using the Bluetooth profile stack, for example.

Referring back to FIG. 3, the method 200 of user authentication further comprises pushing 220 the bluecard onto the PTD using the PAN. In some embodiments, the bluecard is pushed 220 using an object exchange protocol (OBEX) of the PAN. In such embodiments, an object push profile (OPP) of the OBEX may be employed to push 220 the bluecard. Once pushed 220, the bluecard is stored on the PTD for later retrieval during user authentication. For example, the bluecard may be pushed 220 onto the PTD and stored in memory using a built-in functionality of the PTD associated with OBEX and OPP.

In some embodiments, the PAN is a Bluetooth wireless PAN. In other embodiments, another PAN is employed including, but not limited to, the IrDA optical PAN. In some embodiments, the bluecard is created 210 consistent with a vCard file format and comprises one or more fields of information. A first field of the fields comprises the identifier, for example. An optional second field of the fields may comprise a user ID or other user-specific information that identifies the user to the service, for example.

In some embodiments, the method 200 optionally further comprises encrypting 230 the bluecard. Encrypting 230 the bluecard is illustrated in FIG. 3 enclosed in a dashed line box to indicate that it is optional. When performed, encrypting 230 the bluecard encrypts the contents of the bluecard prior to the bluecard being pushed 220 onto the PTD via the PAN, in some embodiments.

In some embodiments, encrypting 230 the bluecard comprises symmetric encryption of the contents of the bluecard. For example, a private key infrastructure may be employed to perform symmetric encryption. The service generally manages and employs the private key infrastructure according to embodiments of the present invention.

In other embodiments, encrypting 230 the bluecard may be asymmetric. For example, asymmetric encryption may comprises employing a pair of keys according to a protocol such as, but not limited to, pretty good privacy (PGP). PGP typically employs one key of the pair for encryption and another key for decryption. The use of two keys allows the encryption key to be made public while the decryption key is kept private. Such public/private key approaches allows for distribution of the public key with limited concern about compromise of the encrypted data. However, according to some embodiments of the present invention, the service is responsible for both encryption and decryption, when encrypting 230 the bluecard is optionally included. As such there is no real need to share or distribute the public key. Thus, either asymmetric or symmetric encryption is equally applicable and useful for encrypting 230 the bluecard according to the method 200 of user authentication.

In some embodiments, creating 210 a bluecard, encrypting 230 the bluecard and pushing 220 the bluecard may be considered together as a registration portion of the method 200 of user authentication, as indicated in FIG. 3. In some embodiments, the registration portion of the method 200 is performed only once to register the user for further access to the service. However, there is no implicit or explicit limit to a number of times the registration portion is performed, according to various embodiments of the present invention.

Referring again to FIG. 3, the method 200 of user authentication further comprises sending 240 the bluecard to the service to authenticate the user. In some embodiments, sending 240 the bluecard is performed during a login portion of the method 200. In particular, the user sends 240 the bluecard to the service during login. The service then employs the bluecard and other information to authenticate the user. Once authenticated, the user may be granted access to the service. While the login portion (i.e., sending 240) of method 200 is illustrated in FIG. 3 following the registration portion (i.e., creating 210, encrypting 230, and pushing 220), in general the login may be performed separately and independently at any time subsequent to performing a first registration portion (i.e., after the bluecard has been pushed 220 onto the PTD a first time).

Sending 240 the bluecard generally comprises selecting a particular bluecard stored on the PTD and pushing the selected bluecard to the service using the PAN. For example, OPP under OBEX may be employed by a user to select and push the bluecard to the service for user authentication.

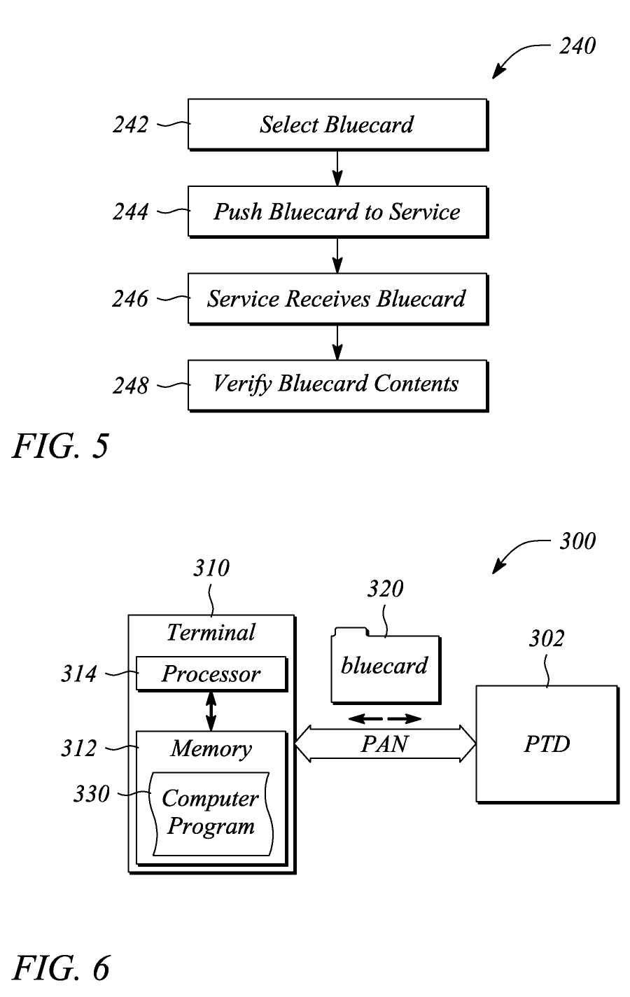

FIG. 5 illustrates a flow chart of a user login portion of the method 200 of user authentication of FIG. 3, according to an embodiment of the present invention. In particular, FIG. 5 illustrates a more detailed flow chart of sending 240 the bluecard to the service of the method 200. As illustrated in FIG. 5, the user login begins with selecting 242 a bluecard. If more than one bluecard is available to the user on the PTD, the user selects 242 an appropriate bluecard for the particular service. Similarly, if more than one service is within range of the PTD, the user may further select a particular service, according to some embodiments. In other embodiments, the selected 242 bluecard selects the service by default.

Sending 240 the bluecard further comprises pushing 244 the selected 242 bluecard to the service. In some embodiments, selecting 242 the bluecard and pushing 244 the selected bluecard are implemented by functions associated with the PAN-enabled PTD. Most PAN-enabled PTDs have built-in functions or application programs that implement and handle selecting and pushing objects to other PAN-enabled devices.

For example, most Bluetooth enabled PTDs (e.g., Bluetooth-enabled cell phones), particularly those that implement OBEX and OPP, provide built-in commands for selecting and pushing objects such as, but not limited to, vCards. The built-in commands may be employed for selecting 242 the bluecard and pushing 244 the selected bluecard, according to the present invention. Bluetooth-enabled PTDs generally implement selecting/pushing as a device-specific set of commands and displays/menus according to and accessed using a user interface of the particular PTD. However, selecting/pushing generally involves using the PTD user interface to: (a) view and select a local or “visible” Bluetooth device (e.g., the service); (b) perform pairing if necessary with the selected Bluetooth device; (c) select an object to push (i.e., selecting 242 the bluecard) from a list of objects available for pushing; and (d) press send to push the object (i.e., pushing 244 the bluecard).

In some cases, a pairing between the PTD may have already taken place previously during the registration portion (e.g., pairing 250) of the method 200 of user authentication and thus, need not be explicitly performed. In other cases, pairing may be accomplished using an on-demand pairing procedure implemented by the PTD. For example, while pairing 250 may have occurred with a first kiosk during registration, if the user is attempting to authenticate with another kiosk of the same service, another pairing may be performed using on-demand pairing. In yet other cases, performing pairing is entirely optional. For example, a service may choose to configure its kiosks/terminals so that pairing is not mandatory for a connection to be made. Such a configuration may facilitate a user accessing multiple kiosks/terminals of the service and/or using a different kiosk/terminal than was used for registering with the service, for example. In yet other cases, the service may not even employ pairing between a PTD and the service during registration before a connection can be made to push the bluecard.

Sending 240 the bluecard further comprises the service receiving 246 the bluecard. Receiving 246 the bluecard comprises extracting the contents of the bluecard. In particular, the identifier (e.g., encoded Bluetooth hardware address of the PTD) is extracted. If the bluecard is encrypted, receiving 246 the bluecard further comprises decrypting the bluecard before extracting the contents.

Sending 240 the bluecard further comprises verifying 248 the contents of the bluecard. In some embodiments, verifying 248 the contents comprises comparing the identifier to the hardware address of the PTD connected to the service via the PAN. The hardware address of the PTD is generally available as a part of a PAN-based connection between the PTD and the service. For example, the Bluetooth profile stack of the Bluetooth wireless PAN at the service-side provides the Bluetooth address of the PTD that is connected with the service. The provided Bluetooth address is compared with the hardware address encoded as the identifier in the bluecard. If the Bluetooth address and bluecard-encoded hardware address are the same, then the comparison yields a match and the bluecard contents are considered to be verified 248, according to some embodiments. A verified 248 bluecard sent 240 to the service may effectively authenticate the user, according to various embodiments.

In some embodiments, verifying 248 the contents further comprises determining that the hardware address received from the connected PTD is actually the hardware address of the user's PTD. In other words, verifying 248 the contents determines that the service is actually connected to the correct PTD. For example, verifying 248 the contents of the bluecard may further comprise verifying the PTD hardware address using a challenge/response process. The service may issue a challenge to the user via the user interface of the service. The challenge may comprise displaying a random pass phrase and instructing the user to enter the pass phrase on the user's PTD (i.e., response), for example. A personal identification number (PIN), password, or another similar knowledge-based means for user verification may also be employed.

FIG. 6 illustrates a block diagram of a service 300 employing user authentication according to an embodiment of the present invention. The service 300 employs user authentication to allow a user having a personal trusted device (PTD) 302 to access the service. As illustrated in FIG. 6, the service 300 comprises a terminal 310 that is connected to the PTD 302 via a wireless personal area network (PAN). The terminal 310 uses the wireless PAN to communicate to the PTD 302 of the user. The wireless PAN is essentially similar to the wireless PAN 130 described above with respect to the user authentication system 100. Similarly, the PTD 302 is essentially similar to the PTD 102 described above with respect to system 100.

The service 300 further comprises a bluecard 320. The bluecard 320 is generated by the service 300 and stored on the PTD 302 using the wireless PAN. The bluecard 320 comprises an identifier created from a hardware address of the PTD 302. According to some embodiments, the bluecard 320 is essentially similar to the bluecard 120 described hereinabove with respect to the user authentication system 100. During user authentication, the user is authenticated with the service 300 by the stored bluecard 320 being transmitted to the terminal 310 using the wireless PAN.

In some embodiments, the service 300, further comprises a computer program 330 stored in memory 312 of the terminal 310 and is executed by a processor 314 of the terminal 310. The computer program 330 has instructions that, when executed, implement user registration and user authentication. User registration comprises receiving the hardware address from the PTD 302, creating the bluecard 320 using the received hardware address to produce the identifier, and pushing the bluecard 320 onto the PTD 302 using the wireless PAN. User authentication comprises receiving a hardware address from the PTD 302, receiving a bluecard 320 from the PTD 302 via the wireless PAN, comparing the identifier of the bluecard 320 with the PTD 302 hardware address, and if the comparison indicates a match between the identifier and hardware address, the user is granted access to the service 300.

While described above largely in terms of wireless PANs, a wired PAN may be employed instead of or in addition to the wireless PAN, according to some embodiments of the present invention. In particular, a wired PAN may be used to interconnect the PTD and the service and further may be used communicate the bluecard therebetween. Moreover, OBEX over the wired PAN may be employed by the service to push a bluecard to the PTD for storage and to send the bluecard from the PTD to the service for user authentication. Other object transfer and/or file transfer protocols associated with a particular wired PAN besides OBEX also may be employed. With the exception of specific embodiments that describe a particular wireless PAN, most of the discussion above applies equally well to the wired PAN as it does to a wireless PAN.

For example, a bluecard employing a vCard format may be transmitted to the PTD for storage or transmitted from the PTD to the service for authentication using a wired PAN that employs a universal serial bus (USB) interconnect. In another example, the PTD may receive and/or transmit the bluecard via Ethernet. The PTD and service may interconnect via a wired docking station at a service-provided kiosk where the docking station physically connects to a wired connector of the PTD, for example. In such an exemplary interface, the wired PAN comprises the docking station and wired connector.

Thus, there have been described various embodiments of a user authentication system and a method of user authentication employing a bluecard that is exchanged between a PTD and a service. Also described are embodiments of a service that employs user authentication using the bluecard. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A user authentication system comprising:
a service employing user authentication to allow a user in possession of a personal trusted device (PTD) to access the service; and
a bluecard comprising a unique identifier derived from a hardware address of the PTD, the bluecard being generated by the service and stored in the PTD,
wherein the PTD and the service communicate with one another over a wireless personal area network (PAN) during user authentication.

2. The user authentication system of claim 1, wherein the wireless PAN is a Bluetooth wireless PAN and the hardware address is a Bluetooth address associated with the PTD.

3. The user authentication system of claim 1, wherein the service is one or both of a point of sale (POS) terminal and an information kiosk.

4. The user authentication system of claim 1, further comprising an updated bluecard comprising the unique identifier, wherein the updated bluecard is generated by the service and stored on the PTD while the user is accessing the service.

5. The user authentication system of claim 1, wherein the bluecard comprises one or more fields of a vCard file format, a first field comprising the unique identifier.

6. The user authentication system of claim 5, wherein the bluecard further comprises a second field comprising a user identifier that identifies the user to a database of the service.

7. The user authentication system of claim 1, wherein the bluecard is encrypted by the service using an encryption key controlled and maintained by the service.

8. The user authentication system of claim 1, wherein the PTD is a Bluetooth compatible cellular telephone that supports OBEX.

9. The user authentication system of claim 1, wherein the service comprises a computer program having instructions that, when executed, implement user registration comprising receiving the hardware address from the PTD, creating the bluecard using the received hardware address to produce the unique identifier, and pushing the bluecard onto the PTD using the wireless PAN.

10. The user authentication system of claim 1, wherein the service comprises a computer program having instructions that, when executed, implement authenticating a user comprising receiving a hardware address from the PTD, receiving a bluecard from the PTD via the wireless PAN, comparing the unique identifier of the bluecard with the PTD hardware address, and granting the user access to the service if the comparison indicates a match between the unique identifier and hardware address.

11. A method of user authentication, the method comprising:
creating a bluecard, the bluecard comprising an identifier derived from a hardware address of a personal trusted device (PTD); and
pushing the bluecard onto the PTD using an object exchange (OBEX) protocol of a personal area network (PAN),
wherein the bluecard is stored by the PTD for later retrieval during user authentication.

12. The method of user authentication of claim 11, wherein the bluecard is created in a format consistent with a vCard file format, the bluecard further comprising user-specific information.

13. The method of user authentication of claim 11, further comprising encrypting the bluecard prior to pushing the bluecard onto the PTD using an object push profile (OPP) of the OBEX protocol.

14. The method of user authentication of claim 11, further comprising selecting and transmitting the bluecard to the service to provide authentication of the user during a login to the service.

15. The method of user authentication of claim 11, further comprising updating the bluecard stored on the PTD using the OBEX protocol of the wireless PAN.

16. A service employing user authentication to allow a user to access the service, the service comprising:
a terminal having a wireless personal area network (PAN) that communicates with a personal trusted device (PTD) of the user; and
a bluecard generated by the service and stored on the PTD using the wireless PAN, the bluecard comprising an identifier created from a hardware address of the PTD, wherein during user authentication, the user is authenticated with the service by the stored bluecard being transmitted to the terminal using the wireless PAN.

17. The service of claim 16, further comprising a computer program that is executed by a processor of the terminal, the computer program comprising instructions that, when executed, implement user registration and user authentication, wherein the user registration comprises receiving the hardware address from the PTD, creating the bluecard using the received hardware address to produce the identifier, and pushing the bluecard onto the PTD using the wireless PAN, and wherein the user authentication comprises receiving a hardware address from the PTD, receiving a bluecard from the PTD via the wireless PAN, comparing the identifier of the bluecard with the PTD hardware address, and if the comparison indicates a match between the identifier and the hardware address, granting the user access to the service.

18. The service of claim 16, wherein the bluecard is encrypted by the service.

19. The service of claim 16, wherein the wireless PAN is a Bluetooth wireless PAN, the PTD being a Bluetooth enabled cellular telephone, the hardware address being a Bluetooth address associated with the cellular telephone, and wherein the bluecard is stored on the Bluetooth enabled cellular telephone by being pushed using an object push profile (OPP) of an object exchange (OBEX) protocol of the Bluetooth wireless PAN.

20. The service of claim 16, wherein the bluecard is a data structure conforming to a vCard file format.
